(19) United States
(12) Patent Application Publication
(10) Pub. No.: US 2016/0363785 A1
(43) Pub. Date: Dec. 15, 2016

(54) LOCKING MECHANISM FOR EYEWEAR

(71) Applicant: Changeable Looks, LLC, Davenport, FL (US)

(72) Inventor: Mark G. Wascher, Davenport, FL (US)

(73) Assignee: Changeable Looks, LLC, Davenport, FL (US)

(21) Appl. No.: 15/143,860

(22) Filed: May 2, 2016

Related U.S. Application Data
(60) Provisional application No. 62/175,567, filed on Jun. 15, 2015.

(51) Int. Cl. G02C 11/02; G02C 5/14

(52) U.S. Cl. CPC G02C 11/02; G02C 5/146; G02C 2200/32

(57) ABSTRACT

A system including a receiving member and a locking member. The receiving member includes a first outer layer, a second outer layer having an ovate opening, and an inner layer having an ovate void corresponding to the ovate opening. A first retaining void is adjacent a first long side of the ovate void and a second retaining void is adjacent a second long side of the ovate void. The locking member has an ovular protrusion secured to its inner surface and adapted to be received by the ovate opening. The first and second retaining voids are adapted to secure the ovular protrusion in a captured configuration within the first retaining void, the second retaining void, and a portion of the ovate void, perpendicular to the ovate void.

### RELATED APPLICATIONS

This application claims the benefit under 35 U.S.C. §119(e) of U.S. Provisional Patent Application Ser. No. 62/175,567 filed on Jun. 15, 2015 and titled Apparatus for a Locking Mechanism used on Eyewear, the entire content of which is incorporated herein by reference.

### FIELD OF THE INVENTION

The present invention relates to systems for securing planar surfaces to one another. More specifically, the present invention relates to a system with a receiving member including an ovular recess and a locking member with an ovular protrusion adapted to be retained by the receiving member.

### BACKGROUND

Eyeglasses have traditionally been used to correct the vision of the wearer. Wearers often have only one pair of eyeglasses, which they must wear every day. This limits the ability of the wearer to coordinate eyewear with outfits or ornamentation related to specific events, such as holidays or sporting events. As a result, there exists a need for eyewear that allows a wearer to change the appearance of the eyewear.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system including a receiving member and a locking member. The receiving member may include a first outer layer, a second outer layer, and an inner layer. The second outer layer may oppose the first outer layer and have an ovate opening disposed thereon. The inner layer may be secured to the first outer layer and the second outer layer. The inner layer may have an ovate void corresponding to the ovate opening. The portion of the first outer layer corresponding to both the ovate void and the ovate void may be continuous. A first retaining void may be adjacent a first long side of the ovate void and a second retaining void may be adjacent a second long side of the ovate void. The locking member may have an inner surface and include an ovular protrusion having a center secured to the inner surface and adapted to be received by the ovate opening. The first and second retaining voids may be adapted to secure the ovular protrusion in a captured configuration within the first retaining void, the second retaining void, and a portion of the ovate void, perpendicular to the ovate void.

The system may include a retaining protrusion secured to an inner side of the second outer layer proximate the ovate opening. The retaining protrusion may be adapted to extend into the first retaining void and contact the ovular protrusion in the captured configuration.

The system may include a retaining protrusion secured to an inner side of the ovular protrusion. The retaining protrusion may be adapted to move into the first or second retaining void and contact the inner layer of the receiving member in the captured configuration.

The ovular protrusion may have a thickness less than a thickness of the inner layer.

The system may include an attachment structure connecting the ovular protrusion to the inner surface of the locking member. The attachment structure may be secured to the center of the ovular protrusion. A first void may be located between a first end of the ovular protrusion and the inner surface of the locking member. A second void may be located between a second end of the ovular protrusion and the inner surface of the locking member.

The first void may have a depth greater than a thickness of the second outer layer and the second void may have a depth greater than a thickness of the second outer layer. The ovular protrusion may be sized to fill substantially the entirety of the ovate void, Indicia may be located on an outer surface of the locking member. The receiving member may be integral to an eyeglass frame. The receiving member may be located on an eyeglass frame temple.

The system may include an eyeglass frame and a locking member. The eyeglass frame may have a temple and may include a receiving member located on the temple. The receiving member may further include a first outer layer, a second outer layer, and an inner layer. The first outer layer may be adapted to be positioned adjacent a user's head when in a worn position. The second outer layer may oppose the first outer layer and have an ovate opening disposed thereon. The inner layer may be secured to the first outer layer and the second outer layer. The inner layer may have an ovate void corresponding to the ovate opening. The portion of the first outer layer corresponding to both the ovate void and the ovate void may be continuous. A first retaining void may be adjacent a first long side of the ovate void and a second retaining void may be adjacent a second long side of the ovate void. The locking member may have an inner surface and include an ovular protrusion, which may have a center secured to the inner surface and adapted to be received by the ovate opening. The first and second retaining voids may be adapted to secure the ovular protrusion in a captured configuration within the first retaining void, the second retaining void, and a portion of the ovate void, perpendicular to the ovate void.

The system may include a retaining protrusion secured to an inner side of the second outer layer proximate the ovate opening. The retaining protrusion may be adapted to extend into the first retaining void and contact the ovular protrusion in the captured configuration. The temple may have an elongate length and the locking member may be sized to extend the entirety of the elongate length.

### BRIEF DESCRIPTION OF THE DRAWINGS

FIG. 1 is a front elevation view of a locking system in an unlocked configuration according to an embodiment of the present invention.

FIG. 2 is a front perspective view of the locking system depicted in FIG. 1 in a captured configuration.

FIG. 3 is a front perspective view of the receiving member of the locking system depicted in FIG. 1.

FIG. 4 is a front elevation view of the receiving member depicted in FIG. 3.

FIG. 5 is a cross-section view taken through line 5-5 of FIG. 3.

FIG. 6 is a cross-section view taken through line 6-6 of FIG. 3.

FIG. 7 is a front perspective view of a locking member of the locking system depicted in FIG. 1.

FIG. 8 is a side elevation view of the locking member depicted in FIG. 7

FIG. 9 is a detail view of the inset labeled 9 in FIG. 8.

FIG. 10 is a side perspective and environmental view of a locking system, with the locking member removed, according to an embodiment of the present invention.

FIG. 11 is a side perspective and environmental view of the locking system depicted in FIG. 10 with the locking member in the captured configuration.

FIG. 12 is a cross-section view taken through line 12-12 of FIG. 3.

FIG. 13 is a front elevation view of the portion of the receiving member as depicted in FIG. 12.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a locking system 100 with a receiving member 101 and a locking member 108.

The receiving member 101 may be a rigid, elongate member. The receiving member 101 may be constructed from material including, but not limited to, plastic, metal, wood, or the like. The receiving member 101 may have three layers. A first outer layer 102 may oppose a second outer layer 103 and an inner layer 105 may be sandwiched between both the first outer layer 102 and second outer layer 103. The combined thicknesses of the first outer layer 102, the second outer layer 103, and the inner layer 105 may be the thickness of the receiving member 101. The inner layer 105, first outer layer 102, and second outer layer 103 may be integrally formed as a monolithic unit, The inner layer 105 may secure to both the first outer layer 102 and the second outer layer 103. An ovate opening 104 may be disposed on the second outer layer 103. The ovate opening 104 may correspond to an align with an ovate void 106 located in the inner layer 105. The ovate opening 104 and the ovate void 106 may have an ovular perimeter. Each ovular perimeter may have two long sides joined together by rounded ends. The ovate opening 104 and the ovate void 106 may be defined by a single oval-shaped perimeter.

The ovate opening 104 and the ovate void 106 may align with one another. The ovate opening 104 and the ovate void 106 may align with a portion of the first outer layer 102 that is continuous. That is, the ovate opening 104 and the ovate void 106 may not extend into the first outer layer 102 and the first outer layer 102 may extend across the entirety of the ovate opening 104 and the ovate void 106.

A retaining void 107 may be located adjacent a long side of the ovate void 106 and align with a portion of the first outer layer 102 and second outer layer 103 that are continuous. The first outer layer 102 and the second outer layer 103 may extend across the entirety of the retaining void 107. A distinct retaining void 107 may be located adjacent each long side of the ovate void 106. Each of the retaining voids 107 may be adapted to receive a rounded end of an ovular protrusion 110. Each of the retaining voids 107 may have a straight side and a curved side joined together with a curved end. The retaining voids 107 may be cooperatively adapted with each other and the ovate void 106 to form a second ovate void with a perimeter having the same shape as the ovate void 106, rotated 90° from the ovate void 106, in the same plane as the ovate void 106, and centered on the ovate void 106. The second ovate void may be adapted to receive, carry, and retain an ovular protrusion 110 when in a captured configuration.

The locking member 108 may be a rigid, elongate member. The locking member 108 may be constructed from material including, but not limited to, wood, plastic, metal, or the like. The locking member 108 may be sized to correspond with at least a portion of the receiving member 101. The locking member 108 may have an inner surface 109 opposing an outer surface. The inner surface 109 may be adapted to contact the second outer layer 103 of the receiving member 101.

An ovular protrusion 110 may secure to the inner surface 109 of the locking member 108. The ovular protrusion 110 may have a thickness, a center, an inner side, and an ovular circumference. The ovular circumference of the ovular protrusion 110 may be smaller than the circumference of the ovate opening 104. The ovular protrusion 110 may be adapted to be received by the ovate opening 104. The ovular protrusion 110 may have a pair of long sides connected to one another by curved ends. The center of the inner side of the ovular protrusion 110 may be secured to the inner surface 109. The inner side of the ovular protrusion 110 may oppose the inner surface 109 of the locking member.

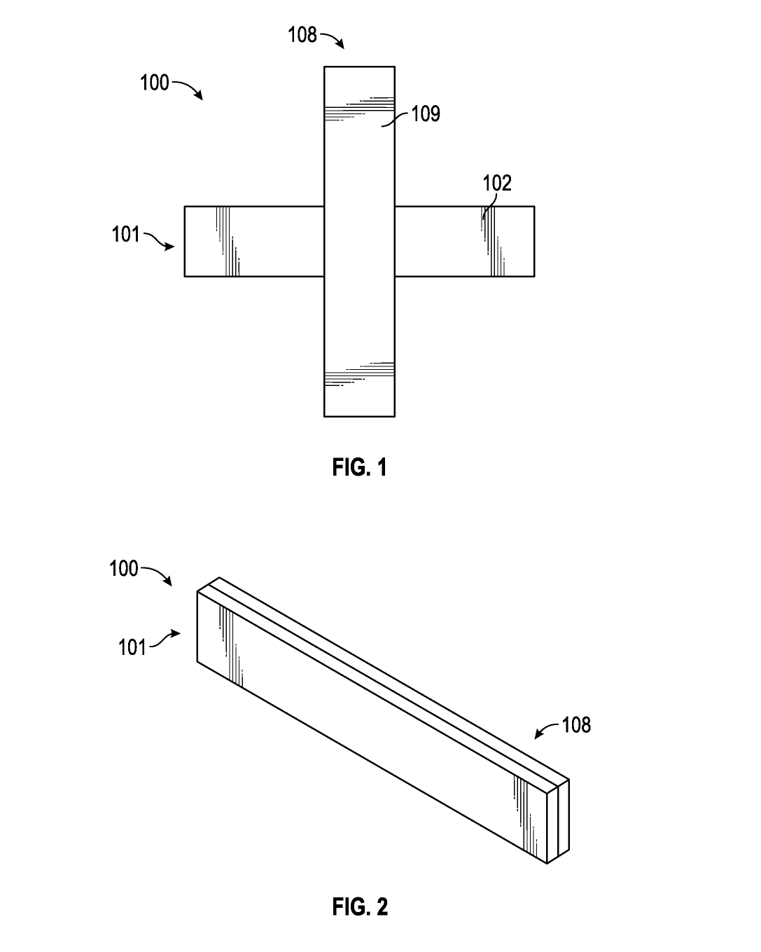

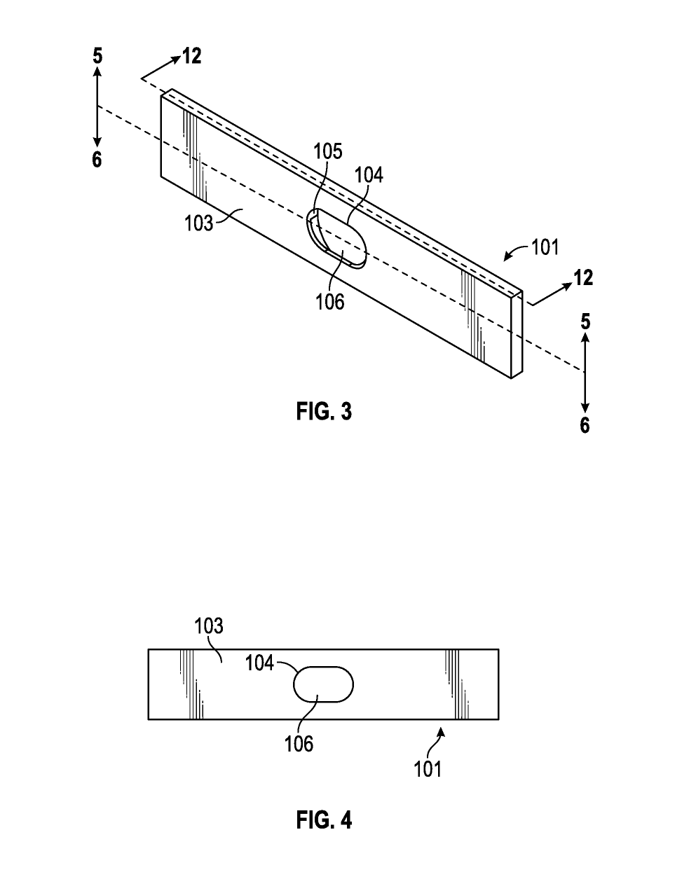

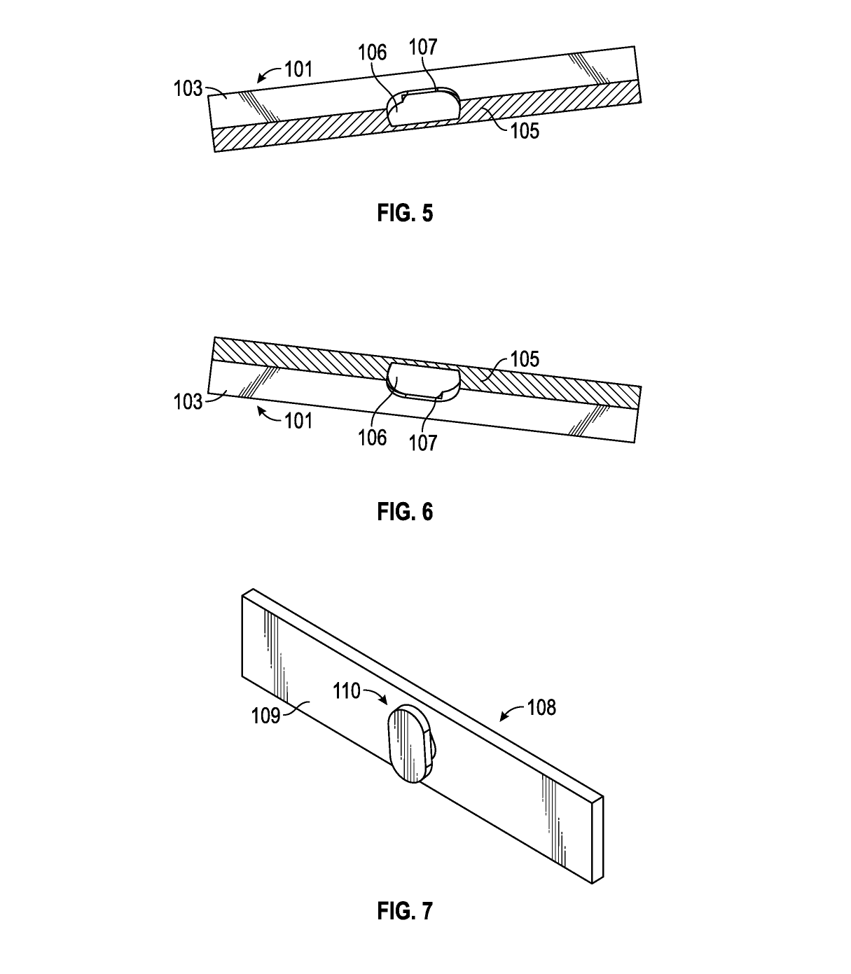

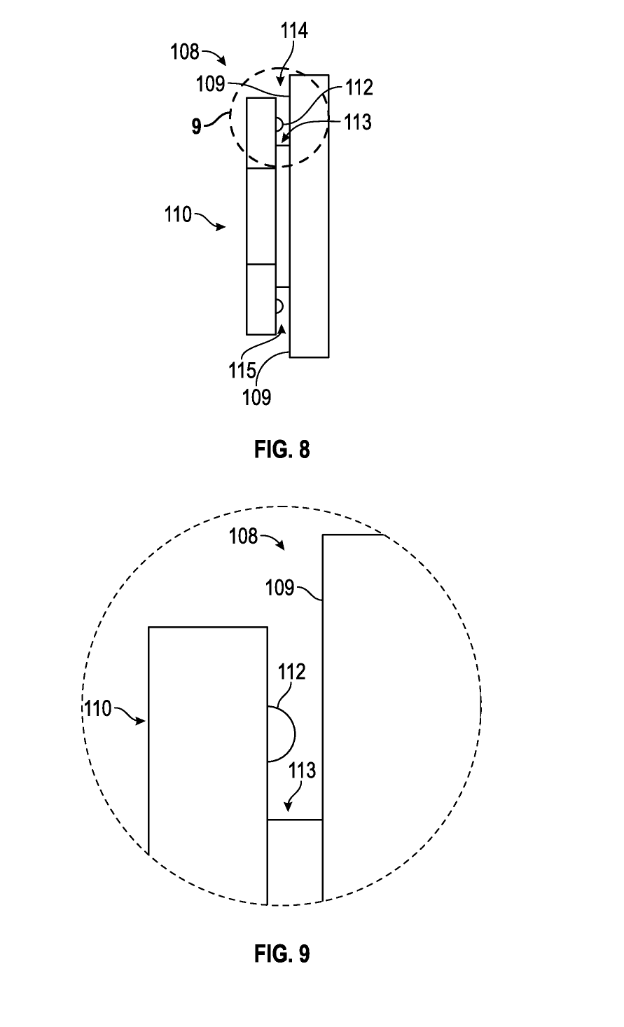

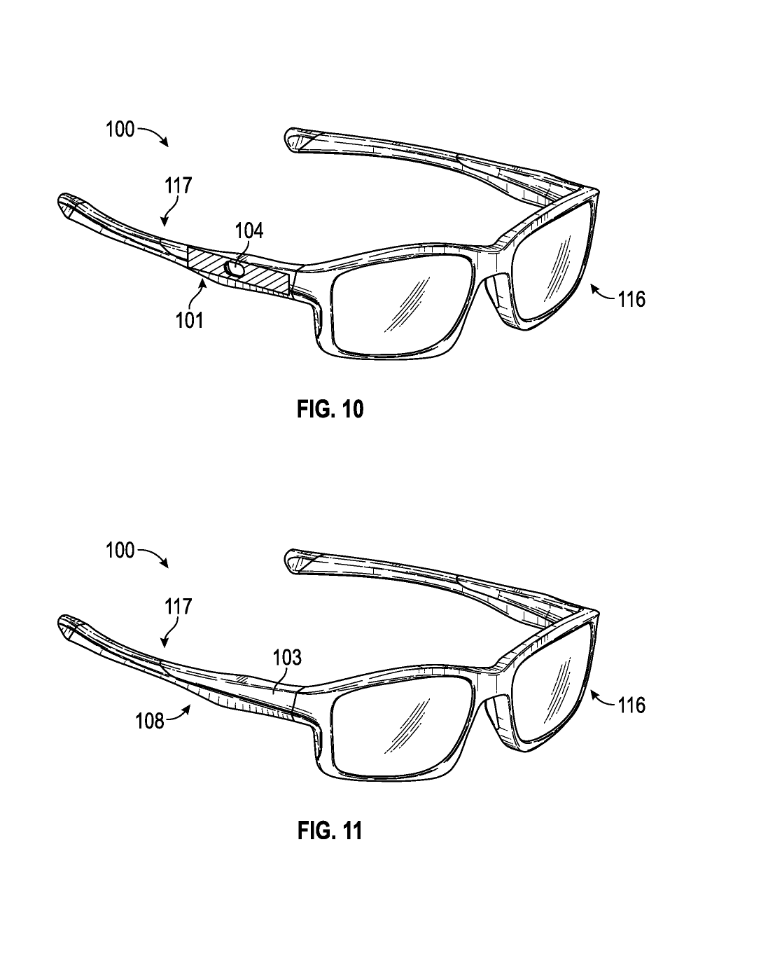

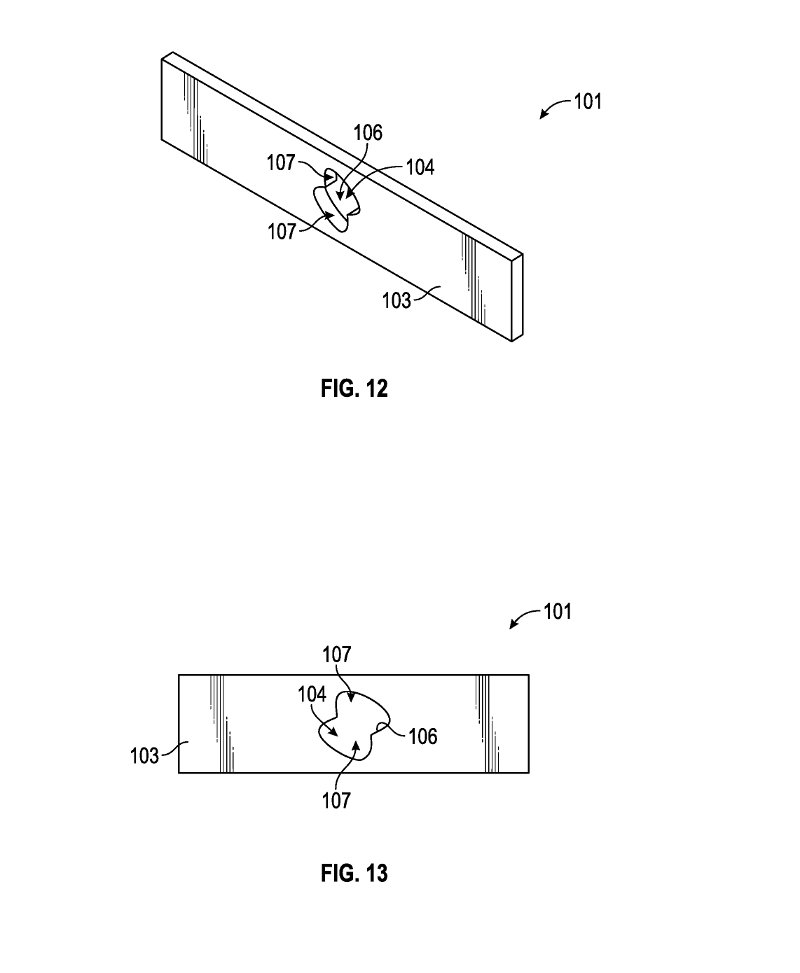

A set of first and second retaining voids 107 located on opposing long sides of the ovate void 106 may be adapted to secure the ovular protrusion 110 in the captured configuration as depicted at least in FIG. 2. The ovate void 106 and the ovate opening 104 may be adapted to receive the ovular protrusion 110 in the unlocked configuration as depicted at least in FIG. 1. The retaining voids 107 may be adapted to allow the locking member 108 to rotate 90° only in a counterclockwise direction from the unlocked configuration to the captured configuration. In the captured configuration, the ovular protrusion 110 may be secured by a first retaining void 107 second retaining void 107, and a portion of the ovate void 106. In the captured configuration, a length along a long side of the ovular protrusion 110 may be secured within the receiving member 101 perpendicular to a length along a long side of the ovate void 106. The retaining voids 107 may be adapted to allow the locking member 108 to rotate 90° only in a clockwise direction from the captured configuration to the unlocked configuration. Alternatively, the retaining void 107 be adapted to allow the locking member 108 to rotate only in a clockwise direction from the unlocked configuration to the captured configuration while allowing the locking member 108 to rotate only in a counterclockwise direction from the captured configuration to the unlocked configuration.

A retaining protrusion 112 may be secured to an inner side of the second outer layer 103. The retaining protrusion 112 may be located on the same side of the ovular protrusion 110 on which the ovular protrusion 110 is secured to the locking member 108. The retaining protrusion 112 may be located on a curved end of the ovular protrusion 110. The retaining protrusion 112 may be located and adapted to move into a retaining void 107 when the locking member 108 is rotated into the captured configuration. The retaining protrusion 112 may be adapted to contact the inner layer 105 of the receiving member 101 when the locking member 108 is rotated into a captured configuration. The retaining protrusion 112 may be adapted to retain the system 100 in a captured configuration with a friction fit. A retaining protrusion 112 may be located on each curved end of the ovular protrusion 110. By way of example, and not as a limitation, the retaining protrusion 112 may be a partial sphere, cylinder, nub, or the like. The retaining protrusion 112 may extend a distance from the inner side of the ovular protrusion 110. The distance may be less than a thickness of the ovular protrusion 110. In one embodiment, the distance may be less than 10% of the ovular protrusion 110.

The retaining protrusion 112 may be located on an inner side of the inner layer 105 of the receiving member 101. In such an embodiment, the retaining protrusion 112 may be adapted to contact an inner side of the ovular protrusion 110 when the locking member 108 is moved into the captured configuration.

When in the captured configuration, a portion of the inner side of the second outer layer 103 may be adjacent at least a portion of the inner surface 109 of the locking member 108. Friction between the surface of the inner side of the second outer layer 103 and the inner surface 109 of the locking member 108 may contribute to maintaining the system 100 in a captured configuration.

In both the captured configuration and the unlocked configuration, the receiving member 101 may lie in a plane parallel to the plane in which the locking member 108 lies. When transitioning from an unlocked configuration to a captured configuration, the receiving member 101 and locking member 108 planes may remain parallel to one another.

The ovular protrusion 110 may have a thickness less than a thickness of the inner layer 105 of the receiving member 101, The ovular protrusion 110 may have a thickness adapted to fit and rotate between the first outer layer 102 and the second outer layer 103 of the receiving member 101. The ovular protrusion 110 may have a thickness adapted to be carried between the first outer layer 102 and the second outer layer 103 while preventing lateral motion of the ovular protrusion 110 between the first outer layer 102 and the second outer layer 103.

An attachment structure 113 may connect the ovular protrusion 110 to the inner surface 109 of the locking member 108. The attachment structure 113 may be a cylindrical member with opposing first and second ends. A first end of the attachment structure 113 may secure to the center of the ovular protrusion 110. A second end of the attachment structure 113 may secure to the inner surface 109 of the locking member 108. The attachment structure 113 may secure to the ovular protrusion 110 at a portion of the ovular protrusion within the long side of the ovular protrusion 110. The rounded ends of the ovular protrusion 110 may not secure to the attachment structure 113.

The ovular protrusion 110 may be connected to the locking member 108 in a configuration creating void between the locking member 108 and the curved end of the ovular protrusion 110. A first void 104 may be located between a first rounded end of the ovular protrusion 110 and the inner surface 109 of the locking member 108. A second void 115 may be located between a second rounded end of the ovular protrusion 110 and the inner surface 109 of the locking member 108. The first void 114 and the second void 115 may have a thickness that is greater than the thickness of the second outer layer 103 of the receiving member 101. The first void 114 and the second void 115 may be adapted to receive a portion of the second outer layer 103 while preventing lateral movement of the second outer layer 103 between the ovular protrusion 110 and the inner surface 109 of the locking member 108.

The ovular protrusion 110 may be sized to fill substantially the entirety of the ovate void 106. The entirety of the ovate void 106 is preferably substantially filled when the perimeter of the ovate void 106 is less than 110% the perimeter of the ovular protrusion 110, equal to or greater than 100% of the perimeter of the ovular protrusion 110, and the shape of the ovular provision 110 perimeter is adapted to be retained within the perimeter of the ovate void 106.

Indicia may be located on an outer surface of the locking member 108. In one embodiment, the indicia may be a pattern, logo, one or more colors, or the like.

The receiving member 101 may be integral to an eyeglass frame 116. The receiving member 108 may be located on an eyeglass frame 116 temple 117. The temple 117 may include all components of the receiving member 101. The receiving member 101 may be integrally formed with the temple 117 as a monolithic unit. In such an embodiment, the eyeglass frame 116 may be adapted to allow the locking member 108 to interface with the receiving member 108 located on the temple 117. The locking member 108 may attach to and detach from the temple 117. Other components of the eyeglass frame 116 may be adapted to allow the locking member 108 to rotate 90° between an unlocked configuration and a captured configuration. In the captured configuration the locking member 108 may be positioned parallel to the eyeglass frame 116 temple 117.

When integrated with an eyeglass frame 116, the receiving member 101 may be located on a temple 117. The first outer layer 102 of the receiving member 101 may be adapted to be positioned adjacent to the user's head when the eyeglass frame 116 covers the user's eyes in a worn position. The temple 117 may be an elongate member and may have an elongate length. The locking member 108 may be sized to extend the entirety of the elongate length of the temple 117. One or more locking members 108 may be interchangeably coupled with the receiving member 101. Indicia may be located on the first locking member 108 such that use of different locking members 108 will alter the appearance of the eyeglass frame 116.

Alternatively, the temple 117 may include all components of the locking member 108 and a receiving member 101 may attach to and detached from the eyeglass frame 116.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A system comprising:
a receiving member comprising:
a first outer layer,
an second outer layer opposing the first outer layer and having an ovate opening disposed thereon, and
an inner layer secured to the first outer layer and the second outer layer,
wherein the inner layer has an ovate void corresponding to the ovate opening,
wherein the portion of the first outer layer corresponding to both the ovate void and the ovate void is continuous, and
wherein a first retaining void is adjacent a first long side of the ovate void and a second retaining void is adjacent a second long side of the ovate void; and
a locking member having an inner surface and comprising:
an ovular protrusion having a center secured to the inner surface and adapted to be received by the ovate opening;
wherein the first and second retaining voids are adapted to secure the ovular protrusion in a captured configuration within the first retaining void, the second retaining void, and a portion of the ovate void, perpendicular to the ovate void.

2. The system according to claim 1 further comprising:
a retaining protrusion secured to an inner side of the ovular protrusion;
wherein the retaining protrusion is adapted to move into the first retaining void and contact the inner layer in the captured configuration.

3. The system according to claim 1 wherein the ovular protrusion has a thickness less than a thickness of the inner layer.

4. The system according to claim 1 further comprising an attachment structure connecting the ovular protrusion to the inner surface of the locking member;
wherein the attachment structure is secured to the center of the ovular protrusion;
wherein a first void is located between a first end of the ovular protrusion and the inner surface of the locking member; and
wherein a second void is located between a second end of the ovular protrusion and the inner surface of the locking member.

5. The system according to claim 4 wherein the first void has a depth greater than a thickness of the second outer layer and the second void has a depth greater than a thickness of the second outer layer.

6. The system according to claim 1 wherein the ovular protrusion is sized to fill substantially the entirety of the ovate void.

7. The system according to claim 1 wherein indicia are located on an outer surface of the locking member.

8. The system according to claim 1 wherein the receiving member is integral to an eyeglass frame.

9. The system according to claim 8 wherein the receiving member is located on an eyeglass frame temple.

10. A system comprising:
an eyeglass frame having a temple, the eyeglass frame comprising:
a receiving member located on the temple, the receiving member further comprising:
a first outer layer adapted to be positioned adjacent a user's head when in a worn position,
an second outer layer opposing the first outer layer and having an ovate opening disposed thereon, and
an inner layer secured to the first outer layer and the second outer layer,
wherein the inner layer has an ovate void corresponding to the ovate opening,
wherein the portion of the first outer layer corresponding to both the ovate void and the ovate void is continuous, and
wherein a first retaining void is adjacent a first long side of the ovate void and a second retaining void is adjacent a second long side of the ovate void; and
a locking member having an inner surface and comprising:
an ovular protrusion having a center secured to the inner surface and adapted to be received by the ovate opening;
wherein the first and second retaining voids are adapted to secure the ovular protrusion in a captured configuration within the first retaining void, the second retaining void, and a portion of the ovate void, perpendicular to the ovate void.

11. The system according to claim 10 further comprising:
a retaining protrusion secured to an inner side of the second outer layer proximate the ovate opening;
wherein the retaining protrusion is adapted to extend into the first retaining void and contact the ovular protrusion in the captured configuration.

12. The system according to claim 10 wherein the ovular protrusion has a thickness less than a thickness of the inner layer.

13. The system according to claim 10 further comprising an attachment structure connecting the ovular protrusion to the inner surface of the locking member;
wherein the attachment structure is secured to the center of the ovular protrusion;
wherein a first void is located between a first end of the ovular protrusion and the inner surface of the locking member; and
wherein a second void is located between a second end of the ovular protrusion and the inner surface of the locking member.

14. The system according to claim 13 wherein the first void has a depth greater than a thickness of the second outer layer and the second void has a depth greater than a thickness of the second outer layer.

15. The system according to claim 10 wherein the ovular protrusion is sized to fill substantially the entirety of the ovate void.

16. The system according to claim 10 wherein indicia are located on an outer surface of the locking member.

17. The system according to claim 10 wherein the temple has an elongate length and the locking member is sized to extend the entirety of the elongate length.

18. A system comprising:
an eyeglass frame having a temple with an elongate length, the eyeglass frame comprising:
a receiving member located on the temple, the receiving member further comprising:
a first outer layer adapted to be positioned adjacent a user's head when in a worn position,
an opposing second outer layer having an ovate opening disposed thereon, and
an inner layer secured to the first outer layer and the second outer layer,
wherein the inner layer has an ovate void corresponding to the ovate opening,
wherein the portion of the first outer layer corresponding to both the ovate void and the ovate void is continuous,
wherein a first retaining void is adjacent a first long side of the ovate void and a second retaining void is adjacent a second long side of the ovate void; and
a locking member having an inner surface and comprising:
an ovular protrusion having a center adapted to be received by the ovate opening, and
an attachment structure connecting a center of the ovular protrusion to the inner surface of the locking member;
wherein a first void is located between a first end of the ovular protrusion and the inner surface of the locking member;
wherein a second void is located between a second end of the ovular protrusion and the inner surface of the locking member;
wherein the first and second retaining voids are adapted to allow 90-degree rotation of the ovular protrusion within the ovate void and secure the ovular protrusion in a captured configuration within the first retaining void, the second retaining void, and a portion of the ovate void, perpendicular to the ovate void; and
wherein the locking member is sized to extend the entirety of the elongate length.

19. The system according to claim 18 wherein the first void has a depth greater than a thickness of the second outer layer;
wherein the second void has a depth greater than a thickness of the second outer layer;
wherein the ovular protrusion has a thickness less than a thickness of the inner layer; and
wherein the ovular protrusion is sized to fill substantially the entirety of the ovate void.

20. The system according to claim 18 further comprising:
a retaining protrusion secured to an inner side of the second outer layer proximate the ovate opening;
wherein the retaining protrusion is adapted to extend into the first retaining void and contact the ovular protrusion in the captured configuration.
